(19) United States
(12) Patent Application Publication
(10) Pub. No.: US 2026/0158626 A1
(43) Pub. Date: Jun. 11, 2026

(54) MULTI-USE THREADED FASTENER DRIVER BIT

(71) Applicant: Escape Climbing, LLC, Little Canada, MN (US)

(72) Inventor: William Fritzke, Bend, OR (US)

(21) Appl. No.: 18/969,741

(22) Filed: Dec. 5, 2024

(51) Int. Cl. B25B 23/00

(52) U.S. Cl. CPC B25B 23/0007

(57) ABSTRACT

Devices, systems, and methods for multi-use, threaded fastener driver bits are provided. A multi-use, threaded fastener driver bit includes an outer bit including a driver portion with a first bit configured to mate with a first female connection feature of a first threaded fastener screw head, the first female connection feature a first shape, the outer bit further including a lumen, an inner bit including a second bit configured to mate with a second female connection feature of a second threaded fastener screw head, the second female connection feature a second, different shape, and a securing mechanism mechanically securing the inner bit within the lumen.

### TECHNICAL FIELD

Embodiments discussed herein regard devices, systems, and methods that include a multi-bit-driver that includes multiple bits mechanically coupled to a single chuck. The multiple bits can include an outer hex bit that circumscribes a driver bit. The multiple bits are useable without changing a configuration of the multi-bit-driver.

### BACKGROUND

Rock climbing gyms set climbing routes that are comprised of a series of climbing holds. The climbing holds are secured to a climbing wall using a variety of different bits. The changing of the bits is onerous and time consuming.

### BRIEF DESCRIPTION OF THE DRAWINGS

FIG. 1 illustrates, by way of example, a side-view diagram of a multi-use bit.

FIG. 2 illustrates the side-view of just the outer bit of the multi-use bit of FIG. 1.

FIG. 3 illustrates the side-view of just the inner bit of the multi-use bit of FIG. 1.

FIGS. 4, 5, and 6 illustrate, by way of example, three-dimensional perspective views of the multi-use bit, the outer bit, and the inner bit, of FIGS. 1-3, respectively.

FIG. 7 illustrates, by way of example, a side-view diagram of another multi-use bit.

FIG. 8 illustrates the side-view of just the outer bit of the multi-use bit of FIG. 7.

FIG. 9 illustrates the side-view of just the inner bit of the multi-use bit of FIG. 7.

FIGS. 10, 11, and 12 illustrate, by way of example, three-dimensional perspective views of the multi-use bit, the outer bit, and the inner bit, of FIGS. 7-9, respectively.

FIG. 13 illustrates, by way of example, a diagram of an embodiment of a method for improved efficiency in fastener driving.

### DETAILED DESCRIPTION

As discussed in the Background, route setters at rock climbing gyms can benefit from a device that can drive a variety of different bits without having to change a bit in a drill. Other crafts, such as carpentry, construction, or other trades that rely on drill functionality can also benefit from the device that can drive a variety of different fasteners without having to the change the bit.

Embodiments include an outer bit and an inner bit. The inner bit is inserted into a lumen in the outer bit. The inner bit is then secured to the outer bit by a retention mechanism. The combination the of the inner bit and the outer bit forms a multi-use bit. The multi-use bit can be used to drive a first screw with a head that mates with the outer bit and can also be used to drive a second screw with a head that mates with the inner bit. The multi-use bit can drive both the first screw and the second screw without having to change the bit.

The inner bit and the outer bit can be co-axial. A chuck of the multi-use bit can be integrally formed with the inner bit or the outer bit. A drive end of the inner bit can extend past a drive end of the outer bit. Both drive ends, the drive end of the inner bit and the drive end of the outer bit, can be exposed for use.

A mating receptacle for the outer bit on the second screw is deeper than the mating receptable for the inner bit on the first screw. This allows the drive end of the inner bit to extend past the drive end of the inner bit less than the depth of the depth of the mating receptacle for the outer bit on the second screw. This allows the presence of the inner bit to not impede use of the outer bit. The configuration of the multi-use bit allows a user to drill the first screw and the second screw with the multi-use bit without having to change a bit or even to change a configuration of the multi-use bit.

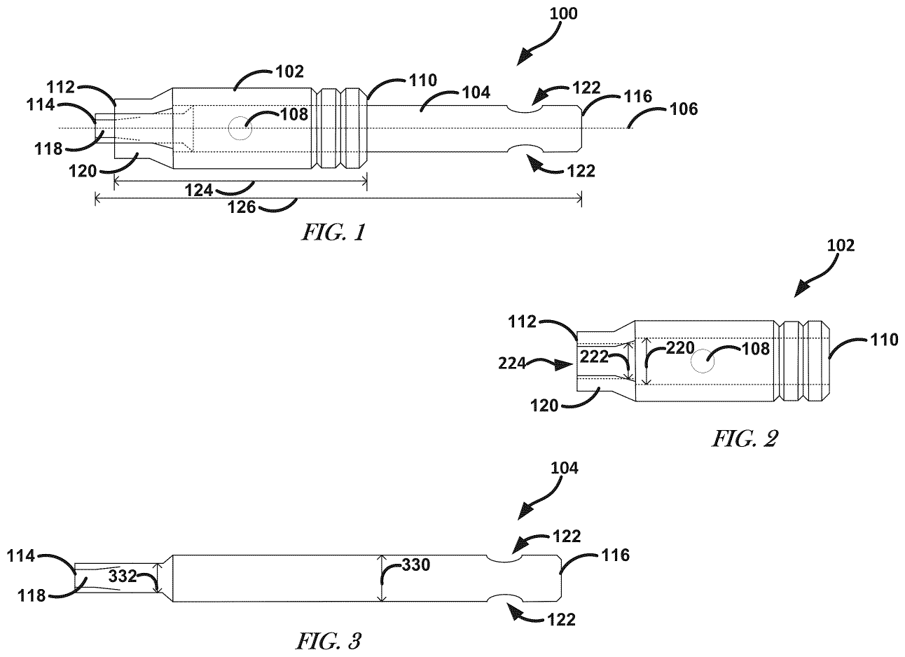

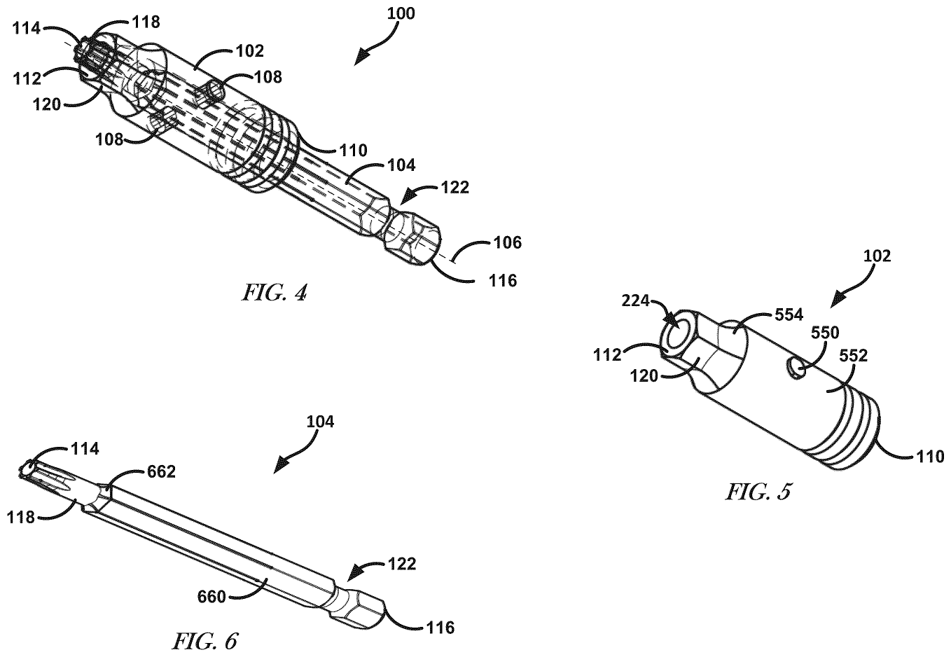

FIG. 1 illustrates, by way of example, a side-view diagram of a multi-use bit 100. The multi-use bit 100 as illustrated includes an inner bit 104 and an outer bit 102. FIG. 2 illustrates the side-view of just the outer bit 102 of the multi-use bit 100 of FIG. 1. FIG. 3 illustrates the side-view of just the inner bit 104 of the multi-use bit 100 of FIG. 1.

The inner bit 104, in FIG. 1, is situated within the outer bit 102. In the configuration of FIG. 1, the inner bit 104 has a greater length 126 than a length 124 of the outer bit 102. The length 126 extends between a driver end 114 and a chuck end 116. The length 124 extends between a driver end 112 and a chuck end 110. When situated for use, the inner bit 104 includes a driver portion 120 (with driver end 114) that extends beyond a driver end 112 of the outer bit 102. The driver portions 118, 120 are configured to engage a mating female connection feature on a head of a screw, bolt, or other threaded fastener.

Threaded fasteners have many head configurations including hex, flat head, Phillips, socket, Pozidriv, Torx, Robertson, and tri-wing, among others. The driver portions 118, 120 are each configured to mate with a female connection feature on the head of the threaded fastener.

The inner bit 104 in FIG. 1, is coaxial with the outer bit 102. When the inner bit 104 is situated in an inner lumen 224 (see FIG. 2) of the outer bit 102, the inner bit 104 and the outer bit 102 have a same central axis 106.

The inner lumen 224 of the outer bit 102 includes a first portion that includes a chuck end 110 and the driver portion 120 that includes the driver end 112. The first portion includes a width 220 that is greater than a chuck portion width 330 (see FIG. 3) of the inner bit 104. The driver portion 120 includes a width 222 that is greater than a driver portion width 332 of the driver portion 118 of the inner bit 104. The width 220 is greater than the width 222. The width 330 is greater than the width 332.

The inner bit 104 includes an indent 122 that is configured to receive a chuck of a driver tool. The inner bit 104 can be inserted into the driver tool and the chuck of the driver tool can be tightened about the indent 122 to secure the inner bit 104 to the driver tool.

The outer bit 102 includes one or more threaded holes 108 therethrough. The threaded holes 108 are configured to receive respective set screws. The set screws can be tightened against the inner bit 104 to secure the inner bit 104 into place within the outer bit 102. The threaded hole 108 and set screws are examples of bit securing mechanisms. Other bit securing mechanisms are possible, such as a retractable ball mechanism like that typically used to secure a socket head to a socket driver. The securing mechanism prevents the inner bit 104 from rotating when secured to the outer bit 102 and in use. The securing mechanism prevents the inner bit 104 from slipping longitudinally (along the central axis 106) within the outer bit 102 when secured to the outer bit 102 and in use.

FIGS. 4, 5, and 6 illustrate, by way of example, three-dimensional perspective views of the multi-use bit 100, the outer bit 102, and the inner bit 104, respectively. There are set screws 550 (see FIG. 5) situated in the threaded holes 108 of the outer bit 102. The outer bit 102 is illustrated with a generally cylindrical body 552 (see FIG. 5) and a hexagonal driver portion 120. Other shapes are possible depending on the threaded fastener to be driven by the outer bit 102 and the manufacturing processes available for making the body. The body 552 and the driver portion 120 are connected by a frustoconical connector portion 554. The outer bit 102 can be manufactured by boring out a cylinder of stock material to form the lumen 224. The driver portion 120 and frustoconical connector portion 554 can be formed through subtractive manufacturing, such as grinding, filing, lathing, stripping, or the like.

The inner bit 104 is illustrated with a generally cylindrical driver portion 118 and a hexagonal body 660 (see FIG. 6). Other shapes are possible depending on the threaded fastener to be driven by the inner bit 104 and the manufacturing processes available for making the body 660. The body 660 and the driver portion 118 are connected by a frustoconical connector portion 662. The outer bit 104 can be manufactured by subtractive manufacturing stock material, such as grinding, filing, lathing, stripping, or the like.

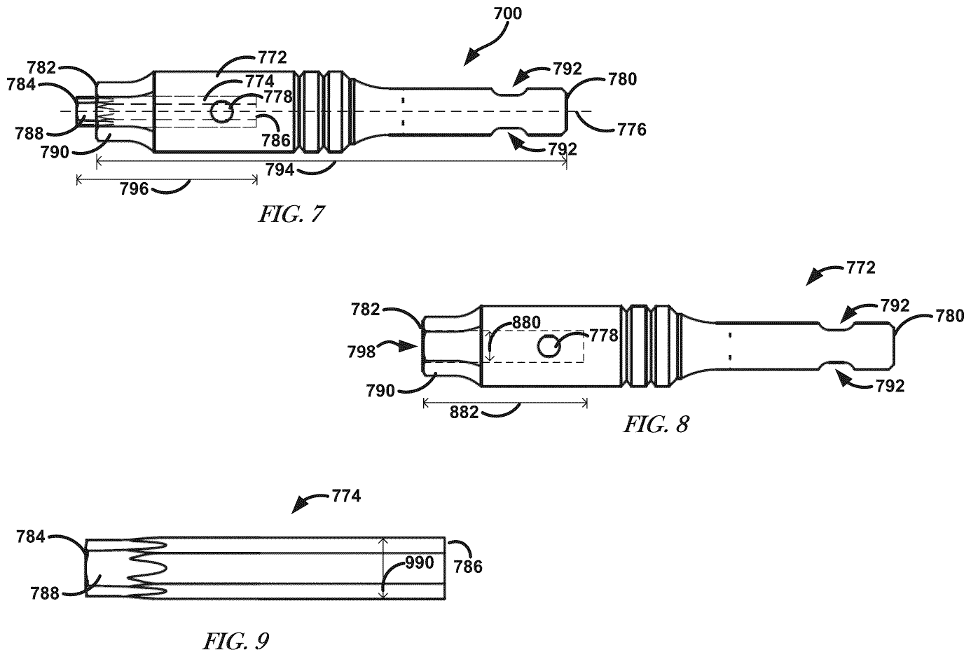

FIG. 7 illustrates, by way of example, a side-view diagram of a multi-use bit 700. The multi-use bit 700 as illustrated includes an inner bit 774 and an outer bit 772. FIG. 8 illustrates the side-view of just the outer bit 772 of the multi-use bit 700 of FIG. 7. FIG. 9 illustrates the side-view of just the inner bit 774 of the multi-use bit 700 of FIG. 7.

The inner bit 774, in FIG. 7, is situated within the outer bit 772. In the configuration of FIG. 7, the outer bit 774 has a greater length 794 than a length 796 of the outer bit 772. The length 796 extends between a driver end 784 and an opposing end 780. The length 794 extends between a driver end 782 and an opposing chuck end 786. When situated for use, the inner bit 774 includes a driver portion 788 (with driver end 784) that extends beyond a driver end 782 of the outer bit 772. The driver portions 788, 790 are configured to engage a mating female connection feature on a head of a screw, bolt, or other threaded fastener. The driver portions 788, 790 are each configured to mate with a female connection feature on the head of the threaded fastener.

The inner bit 774 in FIG. 7, is coaxial with the outer bit 772. When the inner bit 774 is situated in an inner lumen 798 (see FIG. 8) of the outer bit 772, the inner bit 774 and the outer bit 772 have a same central axis 776.

The inner lumen 798 of the outer bit 772 extends from the driver end 782, past a threaded screw hole 778, and terminates before the chuck end 780. The inner lumen 798, as illustrated in FIG. 8 has a uniform width 880. A length 882 of the inner lumen 798 is less than a length 796 of the inner bit 774. A width 990 (see FIG. 9) of the inner bit 774 is less than the width 880 of the inner lumen 798.

The outer bit 772 includes an indent 792 that is configured to receive a chuck of a driver tool. The outer bit 772 can be inserted into the driver tool and the chuck of the driver tool can be tightened about the indent 792 to secure the outer bit 772 to the driver tool.

The out bit 772 includes one or more threaded holes 778 therethrough. The threaded holes 778 are configured to receive respective set screws. The set screws can be tightened against the inner bit 774 to secure the inner bit 774 into place within the outer bit 772.

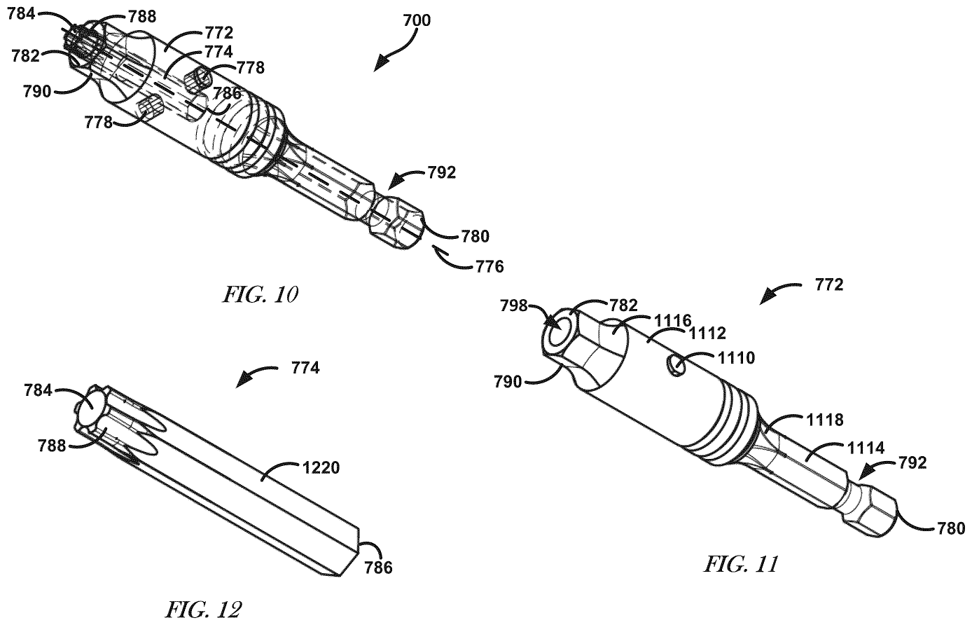

FIGS. 10, 11, and 12 illustrate, by way of example, three-dimensional perspective views of the multi-use bit 700, the outer bit 772, and the inner bit 774, respectively. There are set screws 1110 (see FIG. 11) situated in the threaded holes 778 of the outer bit 772. The outer bit 772 is illustrated with a generally cylindrical body 1112 (see FIG. 11) and a hexagonal driver portion 790. The outer bit 102 is further illustrated as including a hexagonal chuck portion 1114. Other shapes are possible depending on the threaded fastener to be driven by the outer bit 772 and the manufacturing processes available for making the body 1112, driver portion 790, and the chuck portion 1114. The body 1112 and the driver portion 790 are connected by a frustoconical connector portion 1116. Likewise, the body 1112 is connected to the chuck portion 1114 by another frustoconical connector portion 1118.

The outer bit 772 can be manufactured by boring out a cylinder of stock material to form the lumen 798. The driver portion 790, frustoconical connector portion 1116, chuck portion 1114, and frustoconical connector portion 1118 can be formed through subtractive manufacturing, such as grinding, filing, lathing, stripping, or the like.

The inner bit 774 is illustrated with a Torx shaped driver portion 788 and a hexagonal body 1220 (see FIG. 12). Other shapes are possible depending on the threaded fastener to be driven by the inner bit 774 and the manufacturing processes available for making the body 1220. The outer bit 774 can be manufactured by subtractive manufacturing stock material, such as grinding, filing, lathing, stripping, or the like.

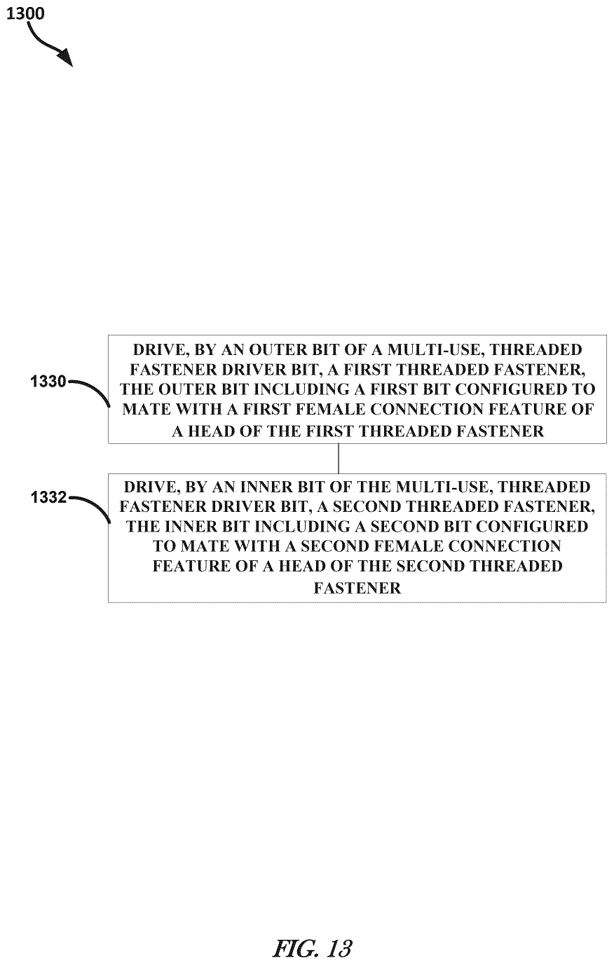

FIG. 13 illustrates, by way of example, a diagram of an embodiment of a method 1300 for improved efficiency in fastener driving. The method 1300, as illustrated, includes driving, by an outer bit of a multi-use, threaded fastener driver bit, a first threaded fastener, the outer bit including a first bit configured to mate with a first female connection feature of a head of the first threaded fastener, at operation 1330; and driving, by an inner bit of the multi-use, threaded fastener driver bit, a second threaded fastener, the inner bit including a second bit configured to mate with a second female connection feature of a head of the second threaded fastener, at operation 1332.

The method 1300 can further include before driving the first and second threaded fasteners, configuring the multi-use threaded fastener driver bit. The multi-use threaded fastener driver bit can be configured by situating the inner bit within a lumen of the outer bit. The multi-use threaded fastener driver bit can be further configured by securing, by a securing mechanism, the inner bit to the outer bit within the lumen. The configuration of the multi-use threaded fastener driver bit can remain unaltered between driving the first and second threaded fasteners.

### Example Embodiments

Example 1 includes a multi-use, threaded fastener driver bit comprising an outer bit including a driver portion with a first bit configured to mate with a first female connection feature of a first threaded fastener screw head, the first female connection feature a first shape, the outer bit further including a lumen, an inner bit including a second bit configured to mate with a second female connection feature of a second threaded fastener screw head, the second female connection feature a second, different shape, and a securing mechanism mechanically securing the inner bit within the lumen.

In Example 2, Example 1 further includes, wherein the lumen traverses an entire length of the outer bit.

In Example 3, Example 2 further includes, wherein the lumen includes a first width through a first portion of the lumen and a second, different width through a second portion of the lumen.

In Example 4, Example 3 further includes, wherein the first portion is a driver bit portion and the second portion is a body portion and the first width is smaller than the second width.

In Example 5, at least one of Examples 2-4 further includes, wherein a length of the outer bit is less than a length of the inner bit.

In Example 6, at least one of Examples 2-5 further includes, wherein the inner bit includes an indent configured to mechanically couple with a chuck of a driver tool.

In Example 7, at least one of Examples 1-6 further includes, wherein the lumen traverses only a portion of a length of the outer bit.

In Example 8, Example 7 further includes, wherein a length of the inner bit is less than a length of the outer bit.

In Example 9, at least one of Examples 7-8 further includes, wherein the outer bit includes an indent configured to mechanically couple with a chuck of a driver tool.

In Example 10, at least one of Examples 1-9 further includes, wherein the outer bit further includes a threaded screw hole extending from an outer surface of the outer bit to the lumen.

In Example 11, Example 10 further includes, wherein the securing mechanism includes a set screw situated in the threaded screw and in physical contact with the inner bit and the outer bit.

In Example 12, at least one of Examples 1 -11 further includes, wherein the first driver bit and the second driver bit include a hex, flat head, Phillips, socket, Pozidriv, Torx, Robertson, or tri-wing, configuration.

In Example 13, Example 12 further includes, wherein the first bit and the second bit include different configurations.

In Example 14, at least one of Examples 12-13 further includes, wherein the first bit and the second bit include same configurations but different sizes, the second bit including a smaller width than the first width.

In Example 15, at least one of Examples 12-14 further includes, wherein the first bit includes a hex configuration and the second driver bit includes a Torx configuration.

In Example 16, at least one of Examples 1-15 further includes, wherein the second bit extends beyond a driver end of the first bit by a first distance.

In Example 17, Example 16 further includes, wherein a depth of the first female connection feature is greater than the first distance and the depth of the second female connection feature is less than the first distance.

Example 18 includes a method comprising driving, by an outer bit of a multi-use, threaded fastener driver bit, a first threaded fastener, the outer bit including a first bit configured to mate with a first female connection feature of a head of the first threaded fastener, and driving, by an inner bit of the multi-use, threaded fastener driver bit, a second threaded fastener, the inner bit including a second bit configured to mate with a second female connection feature of a head of the second threaded fastener.

In Example 19, Example 18 further includes before driving the first and second threaded fasteners, configuring the multi-use threaded fastener driver bit by situating the inner bit within a lumen of the outer bit, and securing, by a securing mechanism, the inner bit to the outer bit within the lumen.

In Example 20, Example 19 further includes not altering the configuration of the multi-use threaded fastener driver bit between driving the first and second threaded fasteners.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A multi-use, threaded fastener driver bit comprising:
an outer bit including a driver portion with a first bit configured to mate with a first female connection feature of a first threaded fastener screw head, the first female connection feature a first shape, the outer bit further including a lumen;
an inner bit including a second bit configured to mate with a second female connection feature of a second threaded fastener screw head, the second female connection feature a second, different shape; and
a securing mechanism mechanically securing the inner bit within the lumen.

2. The multi-use, threaded fastener driver bit of claim 1, wherein the lumen traverses an entire length of the outer bit.

3. The multi-use, threaded fastener driver bit of claim 2, wherein the lumen includes a first width through a first portion of the lumen and a second, different width through a second portion of the lumen.

4. The multi-use, threaded fastener driver bit of claim 3, wherein the first portion is a driver bit portion and the second portion is a body portion and the first width is smaller than the second width.

5. The multi-use, threaded fastener driver bit of claim 2, wherein a length of the outer bit is less than a length of the inner bit.

6. The multi-use, threaded fastener driver bit of claim 2, wherein the inner bit includes an indent configured to mechanically couple with a chuck of a driver tool.

7. The multi-use, threaded fastener driver bit of claim 1, wherein the lumen traverses only a portion of a length of the outer bit.

8. The multi-use, threaded fastener driver bit of claim 7, wherein a length of the inner bit is less than a length of the outer bit.

9. The multi-use, threaded fastener driver bit of claim 7, wherein the outer bit includes an indent configured to mechanically couple with a chuck of a driver tool.

10. The multi-use, threaded fastener driver bit of claim 1, wherein the outer bit further includes a threaded screw hole extending from an outer surface of the outer bit to the lumen.

11. The multi-use, threaded fastener driver bit of claim 10, wherein the securing mechanism includes a set screw situated in the threaded screw and in physical contact with the inner bit and the outer bit.

12. The multi-use, threaded fastener driver bit of claim 1, wherein the first driver bit and the second driver bit include a hex, flat head, Phillips, socket, Pozidriv, Torx, Robertson, or tri-wing, configuration.

13. The multi-use, threaded fastener driver bit of claim 12, wherein the first bit and the second bit include different configurations.

14. The multi-use, threaded fastener driver bit of claim 12, wherein the first bit and the second bit include same configurations but different sizes, the second bit including a smaller width than the first width.

15. The multi-use, threaded fastener driver bit of claim 12, wherein the first bit includes a hex configuration and the second driver bit includes a Torx configuration.

16. The multi-use, threaded fastener driver bit of claim 1, wherein the second bit extends beyond a driver end of the first bit by a first distance.

17. The multi-use, threaded fastener driver bit of claim 16, wherein a depth of the first female connection feature is greater than the first distance and the depth of the second female connection feature is less than the first distance.

18. A method comprising:
driving, by an outer bit of a multi-use, threaded fastener driver bit, a first threaded fastener, the outer bit including a first bit configured to mate with a first female connection feature of a head of the first threaded fastener; and
driving, by an inner bit of the multi-use, threaded fastener driver bit, a second threaded fastener, the inner bit including a second bit configured to mate with a second female connection feature of a head of the second threaded fastener.

19. The method of claim 18, further comprising:
before driving the first and second threaded fasteners, configuring the multi-use threaded fastener driver bit by:
situating the inner bit within a lumen of the outer bit; and
securing, by a securing mechanism, the inner bit to the outer bit within the lumen.

20. The method of claim 19, not altering the configuration of the multi-use threaded fastener driver bit between driving the first and second threaded fasteners.
